(19) United States
(12) Patent Application Publication
(10) Pub. No.: US 2024/0271866 A1
(43) Pub. Date: Aug. 15, 2024

(54) CRYO-COLLECTION SYSTEMS, RELATED METHODS AND HYPERPOLARIZERS WITH THE CRYO-COLLECTION SYSTEMS

(71) Applicant: Polarean, Inc., Durham, NC (US)

(72) Inventor: Andrew K. Dummer, Chapel Hill, NC (US)

(21) Appl. No.: 18/433,767

(22) Filed: Feb. 6, 2024

Related U.S. Application Data
(60) Provisional application No. 63/484,044, filed on Feb. 9, 2023.

(51) Int. Cl. F25J 3/06; F25J 3/02

(52) U.S. Cl. CPC F25J 3/0685; F25J 3/0276; F25J 2205/20; F25J 2215/36; F25J 2270/904

(57) ABSTRACT

Cryo-collection systems are provided with an integrated cooler and heater thermally coupled to an accumulator. The cooler and the heater are electronically, automatically controlled to provide the cooling and then the heating to respectively collect/freeze, then thaw a collected gas, such as ¹²⁹Xe, in the accumulator.

### RELATED APPLICATIONS

This patent application claims the benefit of and priority to U.S. Provisional Application Ser. No. 63/484,044 filed Feb. 9, 2023, the contents of which are hereby incorporated by reference as if recited in full herein.

### GOVERNMENT RIGHTS

This invention was made with Government support under US National Institutes of Health National Heart, Lung and Blood Institute Phase II Small Business Innovation Research Program Grant, Grant number 2R44HL123299-04. The United States Government has certain rights in the invention.

### FIELD OF THE INVENTION

The present invention relates to the cryogenic collection of gas and is particularly suitable for the cryogenic collection of hyperpolarized noble gas for use in magnetic resonance imaging (“MRI”) applications.

### BACKGROUND

Conventionally, MRI has been used to produce images by exciting the nuclei of hydrogen atoms (present in water molecules) in the human body. MRI imaging with polarized noble gases can produce improved images of certain areas and regions of the body. Polarized Helium-3 (“3He”) and Xenon-129 (“¹²⁹Xe”) have been found to be particularly suited for this purpose.

Hyperpolarizers are used to produce and accumulate polarized noble gases. Hyperpolarizers artificially enhance the polarization of certain noble gas nuclei (such as ¹²⁹Xe or ³He) over the natural or equilibrium levels, i.e., the Boltzmann polarization. Such an increase is desirable because it enhances and increases the Magnetic Resonance Imaging (“MRI”) signal intensity, allowing physicians to obtain better images of the substance in the body. See U.S. Pat. No. 5,642,625 to Cates et al. and U.S. Pat. No. 5,545,396 to Albert et al., the contents of which are hereby incorporated herein by reference as if recited in full herein.

In order to produce the hyperpolarized gas, the noble gas is typically blended with optically pumped alkali metal vapors such as rubidium (“Rb”). These optically pumped metal vapors collide with the nuclei of the noble gas and hyperpolarize the noble gas through a phenomenon known as “spin-exchange.” The “optical pumping” of the alkali metal vapor is produced by irradiating the alkali-metal vapor with circularly polarized light at the wavelength of the first principal resonance for the alkali metal (e.g., 795 nm for Rb). Generally stated, the ground state atoms become excited, then subsequently decay back to the ground state. Under a modest magnetic field (10 Gauss), the cycling of atoms between the ground and excited states can yield nearly 100% polarization of the atoms in a few microseconds. This polarization is generally carried by the lone valence electron characteristics of the alkali metal. In the presence of non-zero nuclear spin noble gases, the alkali-metal vapor atoms can collide with the noble gas atoms in a manner in which the polarization of the valence electrons is transferred to the noble-gas nuclei through a mutual spin flip “spin-exchange.”

Conventionally, lasers have been used to optically pump the alkali metals. Various lasers emit light signals over various wavelength bands. In order to improve the optical pumping process for certain types of lasers (particularly those with broader bandwidth emissions), the absorption or resonance line width of the alkali metal can be made broader to more closely correspond with the particular laser emission bandwidth of the selected laser. This broadening can be achieved by pressure broadening, i.e., by using a buffer gas in the optical pumping chamber. Collisions of the alkali metal vapor with a buffer gas will lead to a broadening of the alkali's absorption bandwidth.

In traditional spin exchange optical pumping (SEOP) constant flow systems, a helium-nitrogen-(¹²⁹)xenon gas mixture flows through the optical cell where the SEOP process occurs. Subsequently, the hyperpolarized ¹²⁹Xe is separated and collected from this gas mixture. Traditionally, this is accomplished by flowing the gas through a glass condenser submerged in liquid nitrogen. The ¹²⁹Xe freezes to the interior of the condenser while the remainder of the gas mixture vents from the system. Following the collection, the gas stream is stopped, the remainder of the gas in the condenser is evacuated, the dewar containing the liquid nitrogen is removed, and a vessel containing water is brought up and the condenser is submerged in the vessel with the water, rapidly warming the ¹²⁹Xe back to a gaseous state which is flowably collected in a collection container, such as a TEDLAR bag for administration to patients. For examples of prior cryogenic accumulators, see, e.g., U.S. Pat. Nos. 5,809,801; 6,305,190 and 6,735,977, the contents of which are hereby incorporated by reference as if recited in full herein.

However, there is a need for alternate accumulators that do not require liquid nitrogen and/or that do not require users to move components to facilitate clinical use and reduce manual actions of different users.

### SUMMARY

Embodiments of the present invention provide a cryo-collection system that has an integrated heater and cooler that are both in thermal communication with an accumulator and that does not require the accumulator to be moved to thaw a target collected gas such as ¹²⁹Xe.

Embodiments of the present invention provide a cryo-collection system that electronically, serially directs the integrated heater and cooler to operate to cool to accumulate the target gas, e.g., ¹²⁹Xe. then heat to thaw the accumulated target gas, e.g., ¹²⁹Xe, without require moving components or manual user actions.

Embodiments of the present invention provide a self-contained cryo-collection system with heater and cooler that are each held in fixed position, in thermal communication with an accumulator in a vacuum insulated vessel, the accumulator having at least one gas mixture flow path that defines accumulation surfaces.

The cooler can be provided by a Stirling engine-Stirling cycle based cryocooler.

The heater can be provided by a ceramic heater.

The accumulator can have a condenser structure with a geometry that interfaces with the Stirling engine and with the ceramic heater.

Embodiments of the present invention are directed to cryo-collection systems that include: an accumulator having an entry conduit, an exit conduit and a gas flow path configured for receiving a gas mixture. The gas flow path is in fluid communication with the entry conduit and the exit conduit. The systems also include a heater in thermal communication with the accumulator; a cooler in thermal communication with the accumulator; and a controller in communication with the heater and the cooler to direct the cooler to apply a temperature to the accumulator sufficient to freeze a target gas from the gas mixture and collect the target gas in the accumulator, then direct the heater to apply a temperature to the accumulator sufficient to thaw the collected target gas.

The heater and the cooler can both be concurrently attached to the accumulator.

The cooler can be configured to cool a surface of the accumulator to a temperature in a range of 77K to 165K and the heater can be configured to heat a surface of the accumulator to thereby initiate thaw.

The heater can be a ceramic heater with an accumulator contact surface having a thickness that is greater than a thickness of a bottom of the accumulator

The heater can abut a surface of the accumulator.

The heater can abut a bottom surface of the accumulator.

The cooler can be a Stirling-cycle based cooler with a cold finger that abuts a surface of the accumulator to thermally couple the cooler to the accumulator.

The accumulator can have a coupling channel that can receive a pin or other attachment member to attach the cooler to the accumulator.

The coupling channel can reside in a center location of a bottom of the accumulator.

The heater can have a disk shape with an open center and abuts a portion of a bottom of the accumulator. The cooler can have a cold finger with an end portion that can reside in a center space of the heater and that can abut a portion of the bottom of the accumulator inside the open center of the disk shape.

The accumulator can have a bottom surface. The heater can be configured to abut a first portion of the bottom surface and the cooler can be configured to abut a second portion of the bottom surface.

The first portion of the bottom surface can be annular and the second portion can be circular and reside inside the first portion.

The accumulator can have a disk-shaped body with an interior that may include a plurality of baffles that cooperate to define at least a portion of the gas flow path.

The cryo-collection system can also include a vacuum insulated vessel that can enclose at least part of the accumulator, at least part of the heater and at least an end portion of a cold finger of the cooler.

The accumulator can include a first tube that couples to the entry conduit and a second tube that couples to the exit conduit. The first and second tubes can be non-ferromagnetic metal and the entry and exit conduits can be glass and/or a polymer and can be less thermally conductive than the first and second tubes.

The accumulator can have a low mass body in a range of 40 grams to 200 grams.

The target gas can be ¹²⁹Xe and the gas mixture can be a hyperpolarized gas mixture comprising the target gas.

Other aspects of the present invention are directed to an accumulator for a cryo-collection system. The accumulator includes: a disk-shaped body enclosing at least a portion of a serpentine gas mixture flow path; and first and second spaced apart tubes attached to or formed by the disk-shaped body and in fluid communication with the gas mixture flow path.

The disk-shaped body can have a plurality of baffles that extend at least a major portion of a width/diameter of the disk-shaped body. At least some of the baffles can have a free end closely spaced apart from a side wall of the disk-shaped body and an attached end attached to the side wall of the disk-shaped body.

The accumulator can further include a fixation member receiving channel that projects upwardly from a bottom of the disk-shaped body. The disk-shaped body and the first and second spaced apart tubes can be aluminum and can have a cumulative mass in a range of 40 g-200 g.

Still other aspects are directed to a flow-through spin exchange optical pumping (SEOP) hyperpolarized gas production system for producing hyperpolarized gas that includes: a pressurized gas mixture; a flow-through optical pumping cell in fluid communication with the pressurized gas mixture; and a cryo-collection system with the integrated cooler and heater downstream of and in fluid communication with the flow-through optical pumping cell.

The flow-through SEOP gas production system can further include a flexible patient dose delivery bag downstream of the cryo-collection system and comprising an inhalable bolus of hyperpolarized ¹²⁹Xe collected, then thawed by the cryo-collection system.

The flow-through SEOP gas production system can be configured to have an accumulator, heater and cooler provided as a first cryo-collection system in a first vacuum insulated vessel and a second cryo-collection system provided in a second vacuum insulated vessel enclosing a second heater and at least a portion of a second cooler. The first and second cryo-collection systems can be serially and alternately operable to collect frozen ¹²⁹Xe from the hyperpolarized gas mixture from the optical pumping cell.

Still other aspects of the present invention are directed to methods of collecting hyperpolarized ¹²⁹Xe. The methods include: providing a cryo-collection system comprising an accumulator, an integrated cooler and integrated heater; electronically directing the cooler to cool the accumulator to a sufficient temperature to freeze and collect hyperpolarized ¹²⁹Xe from a gas mixture; electronically directing operation of the heater to heat to a sufficient temperature to thaw the collected hyperpolarized ¹²⁹Xe in the accumulator; and then flowing the hyperpolarized ¹²⁹Xe out of the accumulator into an enclosed flow path.

The method can further include, after the flowing out of the accumulator, filling a container with a bolus amount of hyperpolarized ¹²⁹Xe gas.

The method can further include dispensing the bolus amount of hyperpolarized ¹²⁹Xe gas to a patient for inhalation to thereby allow for gas exchange and/or ventilation evaluation of a lung or lungs of the patient.

The heater can be a ceramic heater thermally coupled to the accumulator.

The heater and the cooler can be concurrently attached to the accumulator.

The heater and the cooler can remain stationary in position during the heating and the cooling.

The cooler can be a Stirling-cycle cooler with a cold finger and an end portion of the cold finger can abut the accumulator.

The heater, the accumulator and at least an end portion of a cold finger of the cooler are at least partially enclosed in a vacuum insulated vessel.

The provided cryo-collection system can be arranged to have first and second cryo-collection systems, each comprising a respective accumulator, integrated cooler and integrated heater, the method further comprises directing either the first or the second cryo-collection system to collect hyperpolarized ¹²⁹Xe to thereby alternate between the use of the first and second cryo-collection systems to reduce or eliminate deadtime between successive collections of hyperpolarized ¹²⁹Xe from the gas mixture.

As will be appreciated by those of skill in the art in light of the above discussion, the present invention may be embodied as methods, systems and/or computer program products or combinations of same. In addition, it is noted that aspects of the invention described with respect to one embodiment, may be incorporated in a different embodiment although not specifically described relative thereto. That is, all embodiments and/or features of any embodiment can be combined in any way and/or combination for any number of desired activities and/or any degree of activity performance complexity or variability. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

The foregoing and other objects and aspects of the present invention are explained in detail herein.

### BRIEF DESCRIPTION OF THE DRAWINGS

Other features of the present invention will be more readily understood from the following detailed description of exemplary embodiments thereof when read in conjunction with the accompanying drawings.

FIG. 1A is a schematic illustration of a hyperpolarizer incorporating a cryo-collection system according to embodiments of the present invention.

FIG. 1B is a schematic illustration of a hyperpolarizer incorporating multiple cryo-collection systems according to embodiments of the present invention.

FIG. 2 is a side view of an example cryo-collection system comprising a cryocooler for a hyperpolarizer according to embodiments of the present invention.

FIG. 3 is an enlarged partial section view of the cryo-collection system shown in FIG. 2.

FIG. 4A is an exploded view of an accumulator of the cryo-collection system shown in FIGS. 2 and 3 according to embodiments of the present invention.

FIG. 4B is an assembled view of the accumulator of the cryo-collection system shown in FIG. 4A.

FIG. 5 is an enlarged top, side perspective view of an accumulator, similar to that shown in FIG. 4B.

FIG. 6 is a side perspective of a partial section of the accumulator shown in FIG. 4B.

FIG. 7 is a front view of the partial section of the accumulator shown in FIG. 6.

FIG. 8 is a top side perspective view of an example heater for the cryo-collection system according to embodiments of the present invention

FIG. 9A is a side perspective view of another example embodiment of a portion of a cryo-collection system providing an accumulator according to embodiments of the present invention.

FIG. 9B is a section view of the device shown in FIG. 9A.

FIG. 10A is a side perspective view of an outer jacket of the device shown in FIG. 9A and shown without the connectors and bent conduits.

FIG. 10B is a side perspective view of the internal member that fits inside the jacket of FIG. 10A and provides a (condensation) gas mixture flow path of the accumulator shown in FIG. 9B.

FIGS. 11A and 11B are side perspective views of yet another example gas mixture flow path for the accumulator of the cryo-collection system according to embodiments of the present invention.

FIG. 12 is a side perspective view of an alternate configuration of part of the accumulator according to embodiments of the present invention.

FIG. 13 is a schematic of a data processing system having a cryo-collection temperature control circuit and/or module according to embodiments of the present invention.

FIG. 14 is a Table of example flow rates and collection times for example collection volumes of xenon according to embodiments of the present invention.

FIG. 15 is a flow chart of example actions for a freeze/thaw process according to embodiments of the present invention.

### DETAILED DESCRIPTION

The present invention will now be described more fully hereinafter with reference to the accompanying figures, in which preferred embodiments of the invention are shown. This invention may, however, be embodied in many different forms and should not be construed as limited to the embodiments set forth herein.

Like numbers refer to like elements throughout. In the figures, layers, regions and/or components may be exaggerated for clarity. The word “Figure” is used interchangeably with the abbreviated forms “FIG.” and “Fig.” in the text and/or drawings. Broken lines illustrate optional features or operations unless specified otherwise. In the description of the present invention that follows, certain terms are employed to refer to the positional relationship of certain structures relative to other structures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will also be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the data or information in use or operation in addition to the orientation depicted in the figures. For example, if data in a window view of the system in the figures is inverted, elements described as “under” or “beneath” other elements or features would then be oriented “over” the other elements or features. Thus, the exemplary term “under” can encompass both an orientation of over and under. The display view may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

As used herein, the term “forward” and derivatives thereof refer to the general direction a noble gas mixture travels as it moves through the hyperpolarizer system; this term is meant to be synonymous with the term “downstream” which is often used in manufacturing environments to indicate that certain material being acted upon is farther along in the manufacturing process than other material. Conversely, the terms “rearward” and “upstream” and derivatives thereof refer to the directions opposite, respectively, the forward and downstream directions.

Also, as described herein, target gases such as polarized gases can be collected, frozen, then thawed, and used. Polarized/hyperpolarized noble gases can be used in MRI applications. For case of description, the term “frozen gas” means that the gas has been frozen into a solid state. The term “liquid gas” means that the frozen gas has been or is being liquefied into a liquid state. The term “gas” alone refers to the gaseous state. Thus, although each term includes the word “gas”, this word, used with a state modifier is used to name and descriptively track the gas which is produced. For hyperpolarized/polarized gas, it is produced via a hyperpolarizer to obtain a polarized/hyperpolarized “gas” product. Therefore, as used herein, the term gas has been used in certain places to descriptively indicate a hyperpolarized noble gas product and may be used with modifiers such as solid, frozen, and liquid to describe the state or phase of that product. Although the below description is primarily described with respect to a hyperpolarized noble gas, such as ¹²⁹Xe, the devices can be used to collect other gases that freeze at 77 deg. K or above, particularly in successive relatively small quantities, such as under about 2 liters.

In some embodiments, the polarized ¹²⁹Xe gas can be produced and formulated to be suitable for internal pharmaceutical human or animal medical purposes.

The term “about” means within plus or minus 10% of a recited number.

The term “polarization friendly” means that the device is configured and formed of materials and/or chemicals that do not induce or cause more than di minimis decay (e.g., less than about 2%) of the polarization of the polarized noble gas, e.g., ¹²⁹Xe.

The term “compact” with respect to optical pumping cells, refers to optical pumping cells that are between about 50 cubic centimeters (“ccs”) to about 1000 ccs, typically between about 100 ccs and 500 ccs, in volumetric capacity.

The term “high volume” means that the polarizer is a continuous flow polarizer (or at least substantially continuous), once activated for production for a given supply of gas mixture to produce at least between about 1.5 ccs to about 500 cc's of polarized noble gas per minute, and/or between about 1000 cc's to about 10,000 cc's, or even more, per hour. The terms “polarizer” and” hyperpolarizer” are used interchangeably herein.

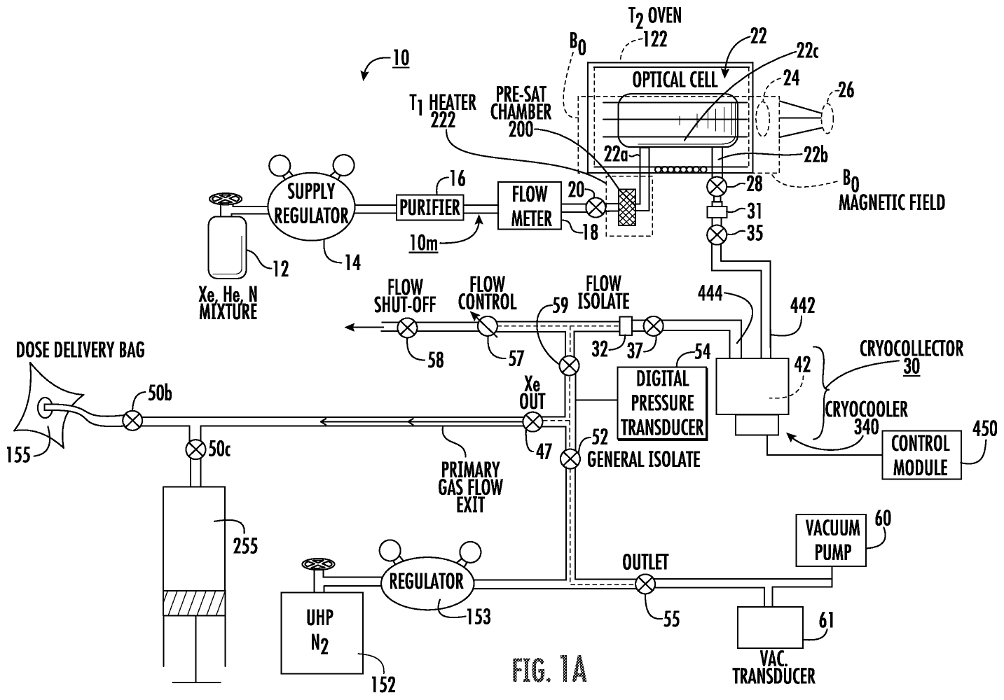

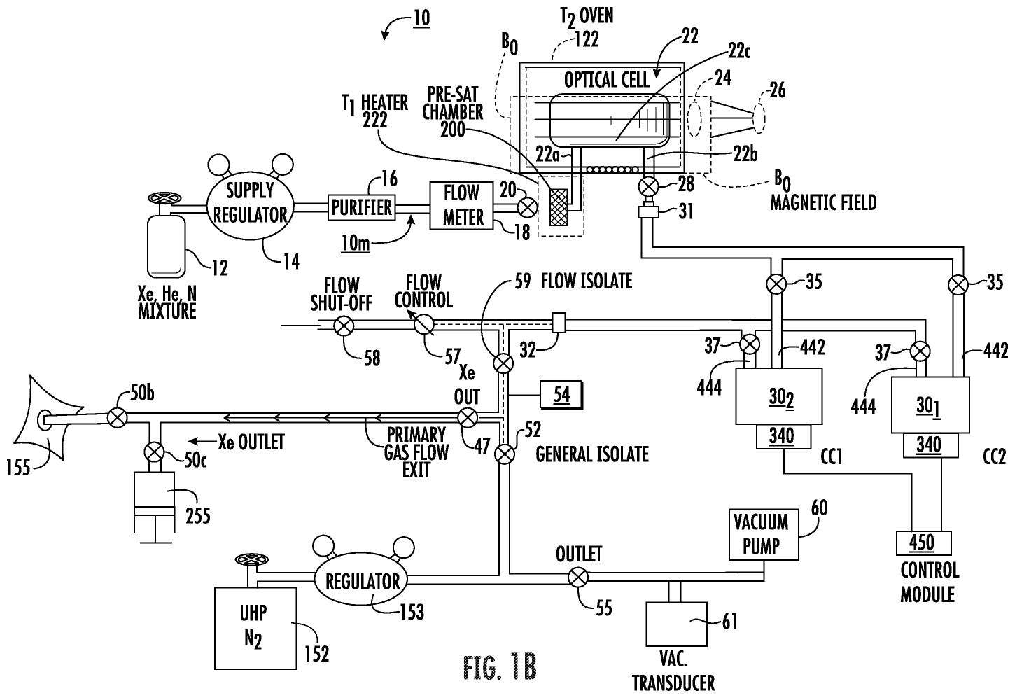

With reference to FIG. 1A, an example hyperpolarizer 10 is shown. The hyperpolarizer 10 includes an optical pumping cell 22 upstream of a cryo-collection system 30. A control module 450 comprising at least one processor can be coupled to the cryo-collection system 30 to electronically control operation thereof. FIG. 1B illustrates that the hyperpolarizer 10 can comprise a plurality of cryo-collection systems 30, shown as first and second systems 301, 302, respectively. It is noted that the hyperpolarizer 10 can comprise more than two such cryo-collection systems 30. Commercial hyperpolarizers comprising gas handling manifolds, a xenon polarizer and supporting devices are available from Polarean, Inc., Durham, North Carolina. Additional components of the hyperpolarizer 10 shown in FIGS. 1A and 1B will be discussed below.

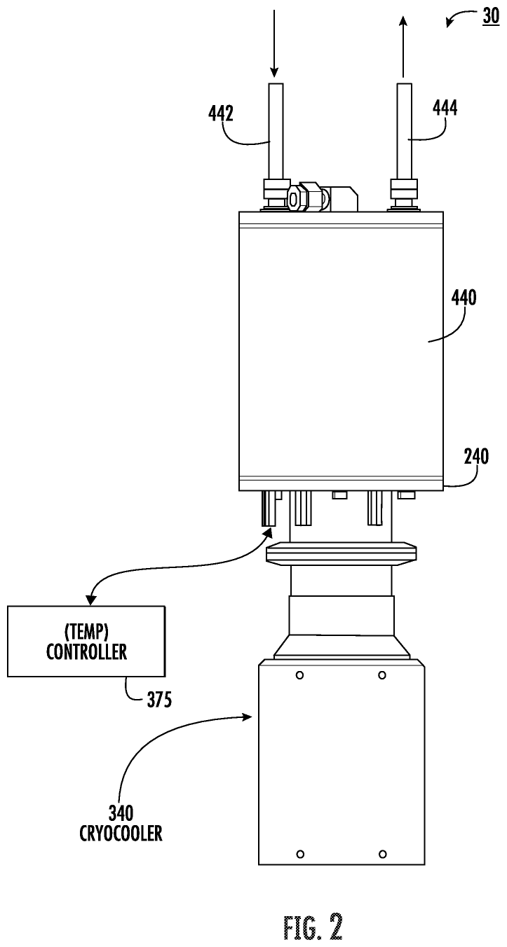

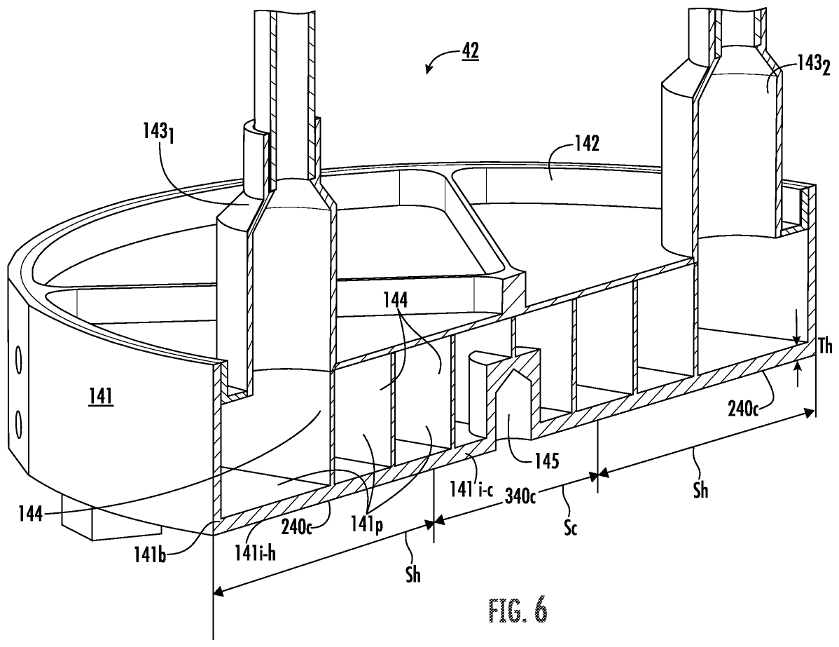

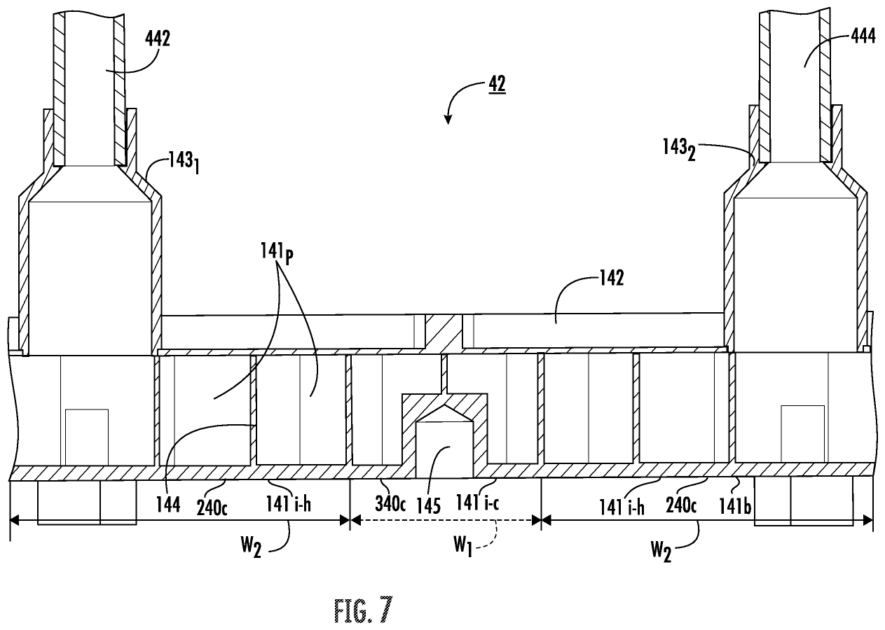

Turning now to FIGS. 2-8, the cryo-collection system 30 comprises an accumulator 42 that condenses and accumulates frozen hyperpolarized ¹²⁹Xe from the hyperpolarized noble gas mixture exiting the optical pumping cell 22 and entering the cryo-collection system 30 through an inlet conduit 442. The cryo-collection system 30 also comprises both an integrated heater 240 and cooler 340, each of which can be controllably, individually turned ON and OFF to facilitate the collection and thaw operations of the ¹²⁹Xe. However, it is noted that the cooler 340 can operate continuously at a constant or changeable temperature, during accumulation and thaw, and the heater 240 can be turned ON only during part of the thaw cycle and but may be configured to provide sufficient heat to cause the thaw even with the cooler 340 operational.

Referring to FIG. 2, the cryo-collection system 30 is shown with a vacuum insulating vessel 440 that encloses the accumulator 42. The cryo-collection system 30 also comprises an inlet conduit 442 and an outlet conduit 444, each in fluid communication with the accumulator 42. At least part of the inlet conduit 442 and at least part of the outlet conduit 444 can reside inside the vacuum insulating vessel 440. The cooler 340 can be a cryocooler with a cold finger 342 with an end portion 342e that resides through a center aperture 241 of the heater 240.

The accumulator 42 can define one or more gas mixture flow paths 141p with at least part of one or more of the gas mixture flow paths 141p thermally coupled to both the cooler 340 and the heater 240.

A controller 375 can be coupled to the heater 240 and optionally also to the cooler 340. Separate controllers may be used to control operation of the cooler 340 and the heater 240.

The heater 240 and the cooler 340 can be fixedly attached to the accumulator 42 thereby not requiring either the heater 240 or the cooler 340 to move to carry out the accumulation and thaw to discharge collected ¹²⁹Xe for flowable downstream collection in a container such as a dose delivery bag.

The heater 240 can contact a portion of the accumulator 42. The cooler 340 can contact a different portion of the accumulator 42. In some embodiments, a contact surface 240c of the heater 240 can contact a base 141 the accumulator 42 and can have a width w₂ and a contact surface 340c of the cooler 340 can contact a base 141 of the accumulator 42 and can have a width w₁, with w₁<w₂ so that the heater 240 contacts a greater surface area of the base 141 of the accumulator 42 than the cooler 340.

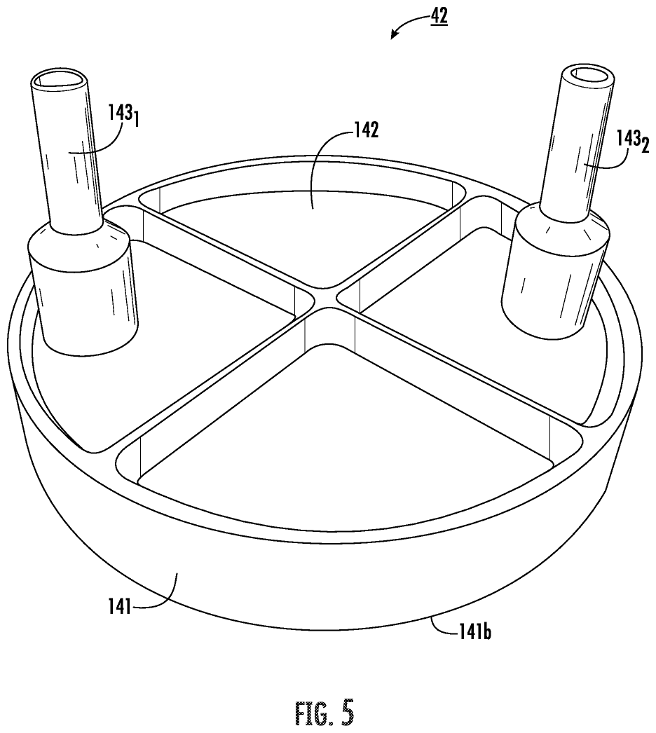

The heater 240 can abut a base 141 of the accumulator 42, to provide a contact surface 240c with a heater contact surface area Sh (FIG. 6) that can be in a range of 4-5 square inches in some embodiments. The cooler 340 can have a cold finger 342 with an end portion 342e that resides through a center aperture 241 of the heater 240 and abuts a bottom 141b of the accumulator 42 about a cooler contact surface 340c having a surface area Sc (FIG. 6) that is less than that of the heater contact surface area Sh.

The contact surface area Se of the cooler 340 can be in a range of about 0.5-2 in², more typically in a range of about 0.7-1 in², in some embodiments. The end portion 342e of the cold finger 342 of the cooler 340 can be about one inch in diameter. This can provide a contact surface area of only about 0.785 sq. in. Technically, the small cooling contact surface is challenging to incorporate into an accumulator for polarized ¹²⁹Xe. Creating a geometry that can interface with this and be sufficiently cooled across a large surface area was technically challenging particularly with the relatively low (e.g., only about 15 W-16 W) cooling capacity of an example cryocooler.

Referring to FIGS. 2-8, the accumulator 42 can comprise a base 141 coupled to a lid 142. The base 141 can have a bottom 141b that provides the accumulator side contact surfaces that define interfaces 141i-h, 141i-c for the different contact surfaces 240c, 340c, of the heater 240 and the cooler 340, respectively. The base 141 can have internal baffles 144 that form part of the gas mixture flow path(s) 141p. It is noted that the internal baffles 144 can alternatively be provided by the lid 142 or by both the lid 142 and the base 141 (not shown). The baffles 144 can create a tortuous, serpentine-like elongate gas mixture flow path while providing surfaces that facilitate condensation/interaction with the ¹²⁹Xe.

The accumulator 42 can have a disk shape with a maximal height dimension that is less than a radial dimension. The bottom 141b of the base 141 can be planar. The accumulator 42 can be aluminum.

The bottom 141b of the base 141 can have a thickness Th (FIG. 6) that is less than a thickness Th (FIG. 8) of the heater contact surface 240c of the heater 240.

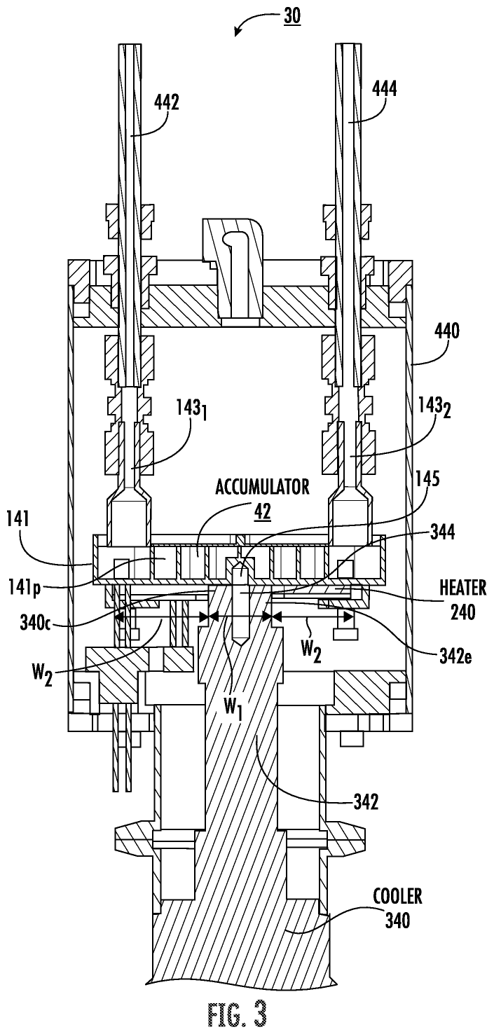

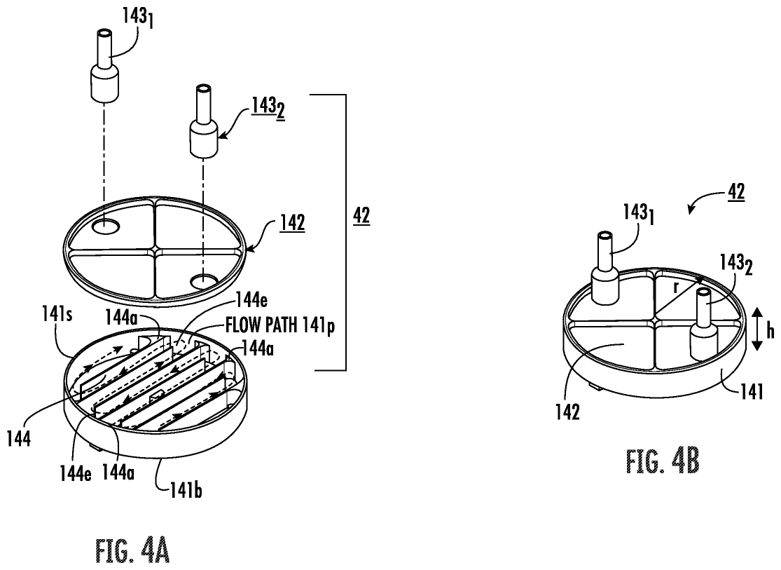

Referring to FIGS. 3, 4A, 4B, for example, metal tubes 143₁, 143₂ can be coupled to the lid or formed in the lid 141 and coupled to the respective inlet and outlet conduits 442, 444 which extend outside the vessel 440. The tubes 143₁, 143₂ define respective entry and exit gas mixture flow channels for the accumulator 42.

The conduits 442, 444 can be of a different material than the tubes 143₁, 143₂. The tubes 143₁, 143₂ can be aluminum. The conduits 442, 444 can be less thermally conducting that the tubes 143₁, 143₂ and may comprise, for example, glass-filled PEEK tubing, to pass from inside the vacuum vessel 440 to the outside for thermal decoupling.

Referring to FIGS. 3, 6 and 7, the base 141 can have a coupling channel 145 that projects upwardly and that can be sized and configured to receive a fixation member 344, such as a coupling pin, to connect the cooler 340 to the accumulator 42.

FIGS. 2-6 show an example configuration of the accumulator 42 for collection of frozen ¹²⁹Xe with a single layer of a plurality of diametrically extending baffles 144 that project upward and extend between the lid 142 and the bottom 141b of the base 141. At least some of the baffles 144 can have a free end 144e spaced from the outer sidewall 141s of the base 141 and an opposing attached end 144a that is attached to the sidewall 141s. The baffles 144 can be arranged so that attached end 144a of neighboring baffles are on opposing ends to provide a serpentine flow path arrangement.

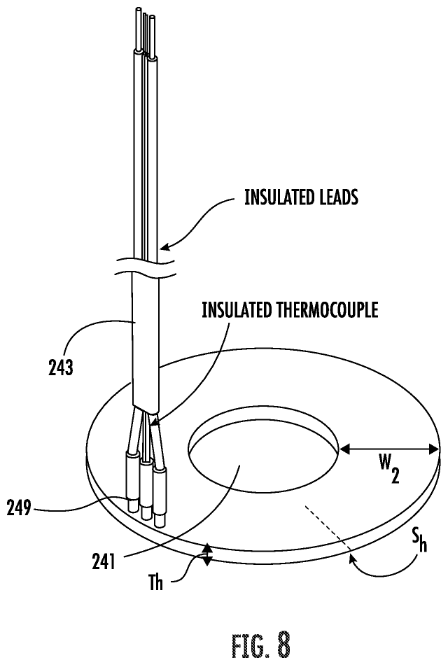

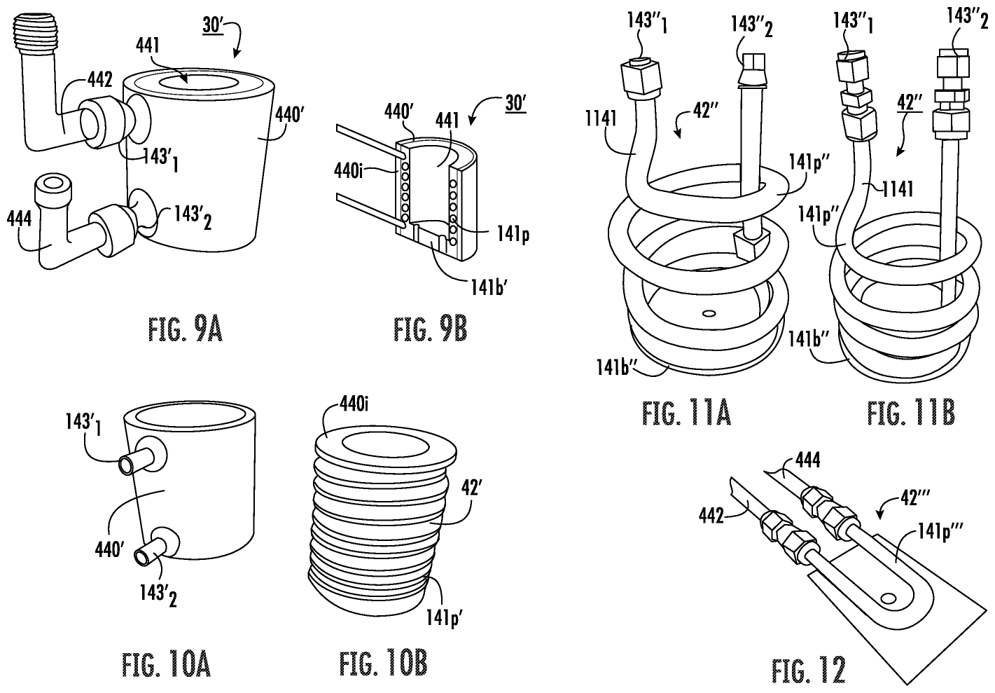

It is noted, however, that the condensation configuration provided by the at least one gas mixture flow path 141p can be provided by other configurations. For example, the accumulator 42 can have one or more stacked layers of flat surface with cooperating baffles. In other embodiments, the accumulator 42 can comprise helical or spiral flow paths, defining one or more gas mixture flow paths 141p. For example, see FIGS. 9A, 9B, 10A, 10B, 11 and 12.

The accumulator 42 can be aluminum. The (condenser) accumulator 42 can be provided with other materials or alloys that provide a small mass, typically in a range of 40 g-600 g, such as in a range of about 40 g to about 200 g or any range therebetween, and good thermal conductivity while being devoid of ferromagnetic materials, e.g., non-ferromagnetic and non-depolarizing materials. To facilitate the process of cool down and the speed of warmup of the thaw, it can be advantageous to provide an accumulator with as low a mass as possible to facilitate the thermal transitions and time for the transitions during the cooling/condensation process and/or the heating/thaw process while also being sufficiently rigid to withstand pressures involved in the freeze/thaw process. Table 1 below shows example xenon vapor pressures (Pa) at different temperatures (K).

TABLE 1
Xenon Vapor Pressures

| P (Pa) | 1 | 10 | 100 | 1k | 10k | 100k |
|---|---|---|---|---|---|---|
| at T (K) | 83 | 92 | 103 | 117 | 137 | 165 |

Generally stated, it takes about 12.3 seconds for every gram of aluminum to go from about 298K (25 C) to about 77K, and that change occurs for every freeze/thaw cycle for serial collections of 129Xe. A 56 g accumulator 42 can theoretically take about 688 s or 11.5 min to cool to 77K. Thus, low-mass accumulators 42 can facilitate a commercially viable production system.

Referring to FIG. 8, the heater 240 can be a ceramic heater with an annular shape with a center aperture 341 and with a thickness Th in a range of 0.01 inches to about 0.2 inches, typically about 0.118 inches.

The heater 240 can be a ceramic heater 3000 W, 400V heater that can provide a max temperature of about 400 degrees Celsius, such as a custom ultramic advanced ceramic heater from Watlow, Inc., St. Louis, MO. However, other heater types and configurations may be used.

The controller 375 (FIG. 2) can be configured to monitor the temperature output of the heater 240 using thermocouples 249 adjacent the accumulator 42 to ensure that it does not exceed a set or defined temperature, such as about 300 deg. C. The controller 375 can be part of or define the temperature control module 450 shown in FIGS. 1A/1B. During, a typical heat cycle for thaw of the accumulated ¹²⁹Xe, measured adjacent the heater contact surface 340c and the bottom 141b of the accumulator 42, can have a maximum temperature of about 273 K for a short time during the overall time of the thaw process for a respective collected, frozen amount of ¹²⁹Xe (typically proximate in time to power up/On of the heater 240 and only for a short time period during an initial part of the thaw). The heater 340 can be operated to run “full on” to deliver its max wattage of heat, such as about 3000 W, for a short time, then turned off. The heater 340 can be turned off once its heat output is at full wattage output. The heater 340 can be configured to deliver a max temperature 200 deg K-300 deg K to the accumulator 42 for a short time, such as a time in a range of about 1 millisecond to 1 minute, then turned off.

In other embodiments, the heater 340 can be operated to deliver a desired temperature to the accumulator 42 and once a surface of the accumulator 42 or a region of the contact surface Sh of the heater 240 reaches the desired temperature, typically in a range of 77K and 165K, warming starts. The heater 340 may be configured to heat the contact surface Sh, to a temperature under 300K, more typically under 275K, to initiate the thaw, then turned OFF or reduced in temperature.

During the thaw, the cooler 340 can be turned OFF, while the heater 240 is turned ON and the accumulator 42 temperature is monitored via the controller 375 (FIG. 2). During the thaw, the maximal temperature of the bottom of the accumulator 42 can be about 273K.

During collection/accumulation/freeze of the ¹²⁹Xe, the cooler 340 can provide a temperature in a range of 77K to 165K, typically in a range of 77K to 103K, more typically in a range of 77K-80K, at the end portion 342e of the cold finger 342. A typical single bolus of ¹²⁹Xe for inhalation can be in a range of 250 mL to 750 mL. The accumulator 42 can be configured to collect the bolus amounts or multiple bolus amounts (which can be subsequently divided into different dose delivery containers) and may have a maximum capacity of 1-1.5 liters (gaseous state), in some embodiments.

Flow rates (for the gas mixture) in the cryo-collection system 30 can typically be from 1 SLM to 5 SLM with the collection time depending completely on the quantity desired to be collected. For a IL collection, this collection time is about 100 minutes for 1 SLM (Standard Liter per Minute), 50 minutes for 2 SLM, 33 minutes for 3 SLM, 25 minutes for 4 SLM, and 20 minutes for 5 SLM.

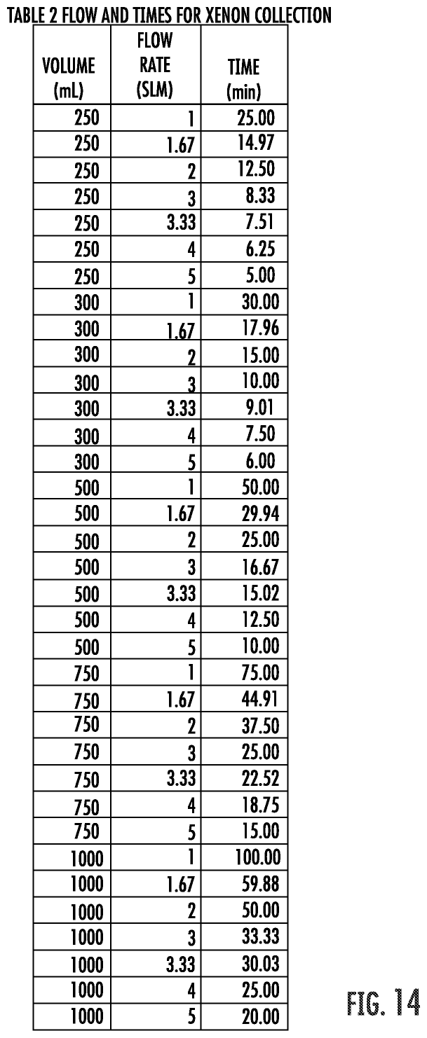

Table 2 in FIG. 14 shows example collection volumes, example gas mixture flow rates in the cryo-collection system 30, and example times for different ¹²⁹Xe collection volumes.

The cooler 340 can be a Stirling cycle and/or Stirling engine-based cryocooler that provides the cold finger 342. For example, the CryoTel® GT cryocooler (about 15 W-16 W) from Sunpower, Inc., Athens, Ohio, a unit of AMETEK, Inc. The cooler 340 can be configured to have active liquid cooling for both a heat rejector and a pressure vessel thereof, both of which can cool with chilled water which can improve cooling capacity.

However, other coolers 340 may be used with the integrated heater 240.

FIGS. 9A, 9B, 10A and 10B illustrate an accumulator 42′ for a cryo-collection system 30′ that includes a vacuum insulated vessel 440′ with inlet and outlet conduits 442′, 444′ that extend laterally outward and that connect to respective metal tubes 143₁′, 143₂′ that extend laterally outward from the vessel 440′. A cylindrical inner member 440i provides the accumulation gas flow path 141p′ as a spiral or helix channel that resides inside the vessel 440′. A closed bottom 141b′ can extend across a center open channel 441 of the inner member 440i and vessel 440′ and can thermally couple to the cooler 340 and heater 240, such as those shown in FIG. 2.

FIGS. 11A, 11B show another example embodiment with a spiral flow channel provided by a shaped conduit 1141 that defines the accumulation flow path 141p″. The bottom 141b″ can be planar and thermally couple to the cooler 340 and heater 240, such as those shown in FIG. 2.

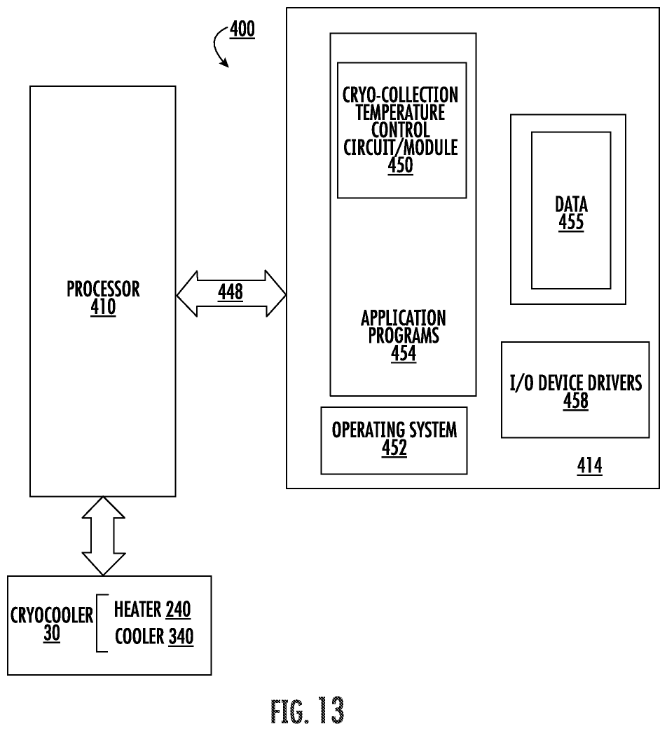

FIG. 12 illustrates another example embodiment of a portion of the accumulator 42′″ which comprises nickel plated aluminum with aluminum tubing providing a gas flow path 141p′″ soldered to an aluminum plate.

In preferred embodiments, the new cryo-collection systems 30 provide an integrated heater 240 and cooler 340 that are both stationary and concurrently attached to the accumulator 42. In preferred embodiments, the heater 240 and cooler 340 are stationary relative to the accumulator 42 and can eliminate moving parts whereby control of the collection and thaw process is improved. However, the heater 240 and/or cooler 340 may also or alternatively be configured to electromechanically move to operative and non-operative (e.g., stow) positions by use of actuators, drive mechanisms and alignment paths (not shown).

The cryo-collection system 30 can be set to a gas mixture collection operating temperature using the cooler 340 and the gas mixture flows through the inlet/entry conduit 442 into the accumulator 42 and the nitrogen and helium vent out the outlet/exit conduit 442. During collection, valves 35, 37, and 58 are OPEN, and the flow control valve 57 is adjusted for the desired flow rate (FIGS. 1A/1B). When a thaw of the collected ¹²⁹Xe is desired, the incoming valve 35 (FIGS. 1A/1B) is closed along with valve 58, and valves 47, and 50b or 50c are opened, the controller 375 or a user electronically directs the heater 240 to activate (and optionally, the cooler to deactivate) whereby collected frozen ¹²⁹Xe is thawed and flowed out the outlet/exit conduit 444 to a container such as a collection vessel 155 such as a TEDLAR bag at the Xe outlet 50b for dispensing to a patient. In some embodiments, a pre-collection container 255 can be used to collect, measure and add N₂ from a medical grade high pressure N₂ source 152, such as a pressurized cylinder in communication with a regulator 153, to the thawed ¹²⁹Xe gas, then the measured amount can be dispensed to a single or multiple bolus collection container 155 such as a flexible bag which can be a TEDLAR bag for transportation to a use cite and dispensing to a patient. In this case, valve 50c is opened during the thaw.

Different flow rates of the gas mixture during accumulation and thaw can be used as well as combinations of different times, temperatures (measured at the bottom 141b of the base 141 of the accumulator 42 whether constant or varying during collection and/or thaw) and flow rates for each. The cooler 340 can provide a cooling temperature to the ¹²⁹Xe and/or bottom of the accumulator 42 that is in a range of 77 deg K to 103 deg K to avoid increased vapor pressures at temperatures at or above 117 degrees K. Single bolus/dose amounts of accumulation/collection times for the ¹²⁹Xe can range from five minutes to 2 hours. See, e.g., FIG. 14.

It is noted that, the present invention is not limited to any particular (hyper) polarizer configuration, embodiments of the invention are particularly suitable for high-volume, flow polarizer systems. These systems can take on various forms and use various components as is known to those of skill in the art. To be clear, different components and arrangements may be used and not all components shown are required.

Thus, referring again to FIG. 1A, as is known by those of skill in the art, this figure illustrates an example of a modified compact flow-through high volume hyperpolarizer which is configured to (continually over a production run) produce and accumulate spin-polarized noble gases, i.e., the flow of gas through the unit is substantially continuous. As shown, the hyperpolarizer unit 10 includes a noble gas (¹²⁹Xe) supply 12 and a supply regulator 14. A purifier 16 can be positioned in the line to remove impurities such as water vapor from the system as will be discussed further below. The hyperpolarizer 10 can also include a flow meter 18 and an inlet valve 20 positioned upstream of the optical (polarizer) cell 22, typically also upstream of the pre-saturation (“pre-sat”) chamber 200. An optic light source such as a laser 26 (either narrow or broad band, typically a diode laser array) is directed into the polarizer cell 22 through various focusing and light distributing means 24, such as lenses, mirrors, and the like. The light source is circularly polarized to optically pump the alkali metals in the cell 22. An additional valve 28 can be positioned downstream of the polarizer cell 22.

Next in line, is the cryo-collection system 30. The cryo-collection system 30 can be connected to the hyperpolarizer 10 by a pair of releasable mechanisms such as threaded members or quick disconnects 31, 32. This allows the cryo-collection system 30 to be easily detached, removed, or added, to and from the system 10.

FIG. 1B illustrates that the system 10 has first and second cryo-collection systems 301, 302, each can be serially operable to alternately collect the hyperpolarized ¹²⁹Xe from the gas mixture exiting the optical cell 22. Alternating between the use of the first and second cryo-collection systems 301, 302, can reduce or eliminate deadtime between successive collections of hyperpolarized ¹²⁹Xe from the gas mixture from the optical cell 22.

A vacuum pump 60 is in fluid communication with the system 10 and may be in communication with a vacuum transducer 61. Additional valves to control flow and direct exit gas can be used and are shown at various points (shown as 52, 55). A shut-off valve 47 can be positioned adjacent, upstream of adjacent an “on-board” exit gas tap at valve 50b. Certain of the valves downstream of the cryo-collector 30 can be used for “on-board” thawing and delivery of the collected polarized gas. The system 10 can also include a digital pressure transducer 54 and a flow control device 57 along with a shut-off valve 58. The shut-off valve 58 can control the flow of gas through the entire system or unit 10 and can be used to turn the gas flow on and off. As will be understood by those of skill in the art, other flow control mechanisms, devices (analog and electronic) may be used within the scope of the present invention.

In operation, a gas mixture is introduced into the system at the gas source 12. As shown in FIG. 1A, the gas source 12 is a pressurized gas tank which holds a pre-mixed gas mixture. The gas mixture includes a lean noble gas (the gas to be hyperpolarized) and buffer gas mixture. Preferably, for producing hyperpolarized ¹²⁹Xe, the pre-mixed gas mixture is about 90% He, about 5% or less ¹²⁹Xe (typically about 1% ¹²⁹Xe), and about 10% N₂. The gas mixture can be passed through the purifier 16 and introduced into the optical (polarizer) cell 22. The valves 20, 28 are on/off valves operably associated with the polarizer cell 22. The gas regulator 14 steps down the pressure from the gas tank source 12 (typically operating at 2000 psi or 136 atm) to about 1-10 atm for the system, e.g., about 1 atm, about 2 atm, about 3 atm, about 4 atm, about 5 atm, or between about 6-10 atm for the system. For systems with spectrally narrowed lasers, lower cell operating pressures of between about 1-3 atm may be particularly desirable.

Thus, during accumulation, the entire manifold (conduit, polarized cell, accumulator, etc.) can be pressurized to the cell pressure (e.g., about 3 atm). The flow in the unit 10 can be activated by opening valve 58 and is controlled by adjusting the flow control means 57. The typical residence time of the gas mixture in the optical cell 22 is about 10-30 seconds, i.e., it takes on the order of 10-30 seconds for the gas mixture to be hyperpolarized while moving through the cell 22.

For lightweight accumulators 42, the gas mixture is typically introduced into the cell 22 at a pressure of between about 1-3 atm and this pressure is about the same as that at the accumulator 42.

Of course, with hardware capable of operating at increased pressures, operating pressures of above 10 atm, such as about 20-30 atm can pressure broaden the Rb and absorb up to 100% of the optical light. In contrast, for laser linewidths less than conventional linewidths, lower pressures can be employed. The polarizer cell 22 can be a high-pressure optical pumping cell housed in a heated chamber with apertures configured to allow entry of the laser emitted light.

As noted above, various techniques have been employed to accumulate and capture polarized gases for use in MRI imaging of patients. For example, U.S. Pat. No. 5,642,625 to Cates et al., describes a high volume hyperpolarizer for spin polarized noble gas and U.S. Pat. Nos. 5,860,295; 5,809,801; 6,305,190; and 6,735,977 describe cryogenic accumulators for spin-polarized ¹²⁹Xe. These references are hereby incorporated by reference as if recited in full herein. As used herein, the terms “hyperpolarize” and “polarize” and the like, mean to artificially enhance the polarization of certain noble gas nuclei over the natural or equilibrium levels. Such an increase is desirable because it allows stronger imaging signals corresponding to better MRI images of the substance and a targeted area of the body. As is known by those of skill in the art, hyperpolarization can be induced by spin-exchange with an optically pumped alkali-metal vapor or alternatively by metastability exchange. See Albert et al., U.S. Pat. No. 5,545,396, which is incorporated by reference as if recited in full herein.

Turning again to FIG. 1A, an example hyperpolarizer 10 is shown that may include at least one pre-saturation chamber 200. The chamber 200 can be relatively compact and can reside adjacent the entry port of the optical pumping cell 22. The polarizer 10 can include other components as is known by those of skill in the art (and are described below). The term “chamber” with respect to the pre-sat member and/or section of the gas flow path, refers to a region of a flow path that flowably supplies noble gas mixture into the optical pumping cell 22 with vaporized alkali metal. Thus, the pre-sat chamber 200 is configured to house alkali metal that is vaporized and introduced into a flowing noble gas mixture, then into the optical pumping cell 22. The pre-sat chamber 200 can be a detachable component or an integral part of the flow path. The pre-sat chamber 200 can have an Area Ratio of surface area to cross-sectional area that is between 20 and 500, more typically between 20 and 200 as will be discussed below.

In some embodiments, the chamber 200 can be tubular and have a short length such as about between about 0.5 inches to about 2 inches, typically about 1.25 inches.

Optionally, the optical pumping cell 22 can include pairs of conduit legs 22a, 22b that extend to valves V, e.g., 20, 28 (which are typically KONTES valves).

The optical pumping cell 22 can be relatively compact with a volume capacity of between about 100 cc to about 500 cc, such as about 100 cc, about 200 cc, about 300 cc, about 400 cc and about 500 cc. The optical pumping cell 22 can also have larger sizes, such as between about 500 cc-1000 cc, for example. The chamber 200 can have a length L that is between about 0.5 inches to 6 inches long, typically between about 1-3 inches, such as about 1.25″ long. The chamber 200 can have a primary body segment with a cross-sectional height W (e.g., diameter, when tubular) that can be between about 0.25 inches to about 1 inch across, typically about 0.5″.

The pre-sat chamber 200 can contain between about 0.25 g to about 5 grams of Rb, typically between about 0.5 to about 1 gram of Rb, (measured “new” as shipped by an OEM or supplier and/or prior to a first use).

As shown in FIG. 1A, the hyperpolarizer 10 can comprise at least two different temperature-controlled zones T1, T2, one (T1) for the pre-saturation chamber 200 and at least one other (T2) for the optical pumping cell 22 so that T1>T2. The volume of the pre-saturation chamber V1 is also less than the volume V2 of the optical pumping cell 22.

In some embodiments, the pre-saturation chamber 200 in the T1 zone can be heated to temperatures between about 140 degrees C. and 300 degrees C., more typically between about 140 degrees Celsius to about 250 degrees Celsius, such as 140 degrees C., 150 degrees C., 160 degrees C., 170 degrees C., 180 degrees C., 190 degrees C., 200 degrees C., 210 degrees C., 220 degrees C., 230 degrees C., 240 degrees C. and 250 degrees C. The second temperature zone (T2) for the optical pumping cell 22 can be configured to have a temperature that is less than T1, typically with a temperature between about 70 degrees C. to about 200 degrees C., more typically between about 90 degrees C. to about 150 degrees C., such as about 95 degrees C., about 100 degrees C., about 110 degrees C., about 120 degrees C., about 140 degrees C. and about 150 degrees C., to maintain vapor pressure, in some embodiments. The zone T2 may also be configured to apply a temperature gradient of decreasing temperature from a greater temperature at a region proximate the inlet to a lower temperature proximate the exit, typically with a change that is about 10 degrees C., about 15 degrees C., about 20 degrees C., about 25 degrees C. or about 30 degrees C., for example.

The temperature zone T1 can comprise at least one (pre) heater 222 that can provide the desired heat to increase the temperature including conductive and/or convection heaters. The at least one heater 222 can be an electric heater. The at least one heater 222 can comprise one or more of an oven, infrared heaters, resistive heaters, ceramic heaters, heat lamps, heat guns, laser heaters, heat blankets (e.g., heat blanket that can be wrapped about the chamber 200 with at least one insulation layer, typically comprising Nomex®-fiberglass fibers, but other insulation materials may be used), pressurized hot fluid spray and the like. The at least one heater 222 can employ a plurality of different heater types. The at least one heater 222 can comprise an oven that encases or partially encases the chamber 200. The at least one heater 222 can comprise an internal heater in the chamber 200. The temperature zone T2 can also comprise at least one heater 122, typically comprising an oven. Each zone can be independently controlled to maintain a desired temperature or temperatures.

The hyperpolarizer 10 can be configured so that alkali metal is loaded only into the pre-saturation chamber 200 that is outside of the pumping laser exposure region of the cell 22.

The optical (pumping) cell 22 can be mounted to a vacuum manifold and the alkali metal A (e.g., Rb) can be “chased” into the pre-saturation chamber 200. The optical cell 22 can then be operated in a modified conventional high-volume hyperpolarizer 10 where heat is applied primarily to the pre-saturation chamber 200 and to a lesser (cooler degree) to the optical cell 22.

In some particular embodiments, in contrast to a normal optical pumping cell 22 maintained at between 160-180 degrees C., the optical pumping cell 22 can be held at a primary body temperature that is maintained at 150 C or less, such as between 100 C and 150 C, including, for example, about 100 degrees C., about 110 degrees C., about 120 degrees C., about 130 degrees C., about 140 degrees C., while Rb saturated vapor is picked up by the flowing gas stream in the pre-saturation chamber 200, which can be maintained at temperatures ranging from between about 150 to 250 degrees C., depending on the desired flow rates. In some particular embodiments, the pre-sat chamber 200 can be held at between 150 degrees C. to about 160 degrees C.

In some embodiments, the hyperpolarizer 10 employs the optical pumping cell 22 at a pressure of about 3 atm. It is contemplated that a spectrally narrowed laser, that has been detuned by about 0.25-0.50 nm from the alkali DI resonance at that pressure. As will be understood by one of skill in the art, a small pressure shift in resonance occurs from vacuum to the 3 atm pressure which can depend on the buffer gas composition. For example, in vacuum, Rb DI resonance is at 794.8 nm, whereas at 3 atm with the same buffer gas mixture, it is shifted to a slightly lower wavelength of 794.96 nm.

The hyperpolarizer 10 can employ helium buffer gas to pressure broaden the Rb vapor absorption bandwidth. The selection of a buffer gas can be important because the buffer gas—while broadening the absorption bandwidth—can also undesirably impact the alkali metal-noble gas spin-exchange by potentially introducing an angular momentum loss of the alkali metal to the buffer gas rather than to the noble gas as desired.

Hyperpolarized gas, together with the buffer gas mixture, exits the optical (pumping/polarizer) cell 22 and travels along the manifold (e.g., conduit), then enters the cryo-collection system 30. The gas mixture is directed into the accumulator 42 and along a gas mixture flow path 141p. As discussed above, in operation, the hyperpolarized ¹²⁹Xe gas is exposed to temperatures below its freezing point and collected as a frozen product in the accumulator 42. The remainder of the gas mixture remains gaseous and exits the accumulator 42 through outlet/exit conduit 444 (FIG. 2). The hyperpolarized gas is collected in the accumulator 42 (as well as stored, transported, and preferably thawed) in the presence of a magnetic field, generally on the order of at least 500 Gauss, and typically about 2 kiloGauss, although higher fields can be used. Lower fields can potentially undesirably increase the relaxation rate or decrease the relaxation time of the polarized gas. The magnetic field can be provided by permanent magnets positioned about a magnetic yoke. Once a desired amount of hyperpolarized gas has been collected in the accumulator 42, valve 35 can be closed. The manifold of the hyperpolarizer 10 downstream of the valve 28 can be allowed to depressurize to about 1.5 atm before the flow valve 58 is closed. After closing the flow valve 58, valves 52 and 55 can be opened to evacuate the remaining gas in the manifold. Once the outlet plumbing is evacuated, valve 59 is closed A receptacle/container such as a bag or other vessel can be attached to the outlet 50. Valves 47, 50b, 52, and 55 can be opened to evacuate the attached bag 155.

Alternatively, in some embodiments like FIGS. 1A and 1B, the manifold can be configured to pull a vacuum on the bag (or vessel into which to ¹²⁹Xe is to be expanded) during the entire collection time. In this case, valve 59 is closed during flow, and valves 47, 50b, 52, and 55 are open. In this configuration, the valves 52 and 55 are closed during the thaw so that thawed ¹²⁹Xe gas is not lost to the vacuum pump.

If the valve 52 is not closed, then valve 55 is preferably closed to prevent the evacuation of polarized thawed gases. The flow channels on the downstream side of the cell 22 can be formed from materials which minimize the decaying effect on the polarized state of the gas. Coatings can also be used such as those described in U.S. Pat. No. 5,612,103, the disclosure of which is hereby incorporated by reference as if recited in full herein. In the “on-board” thaw operation, valve(s) 37 in the exit flow path is opened to let the gas out. It then proceeds through valve 47 to outlet 50.

The cryo-collection system 30 can be configured to collect the hyperpolarized ¹²⁹Xe in the accumulator 42 in an ultra-high vacuum chamber provided by the vacuum insulated vessel 440 (FIGS. 2, 3) to thermally isolate the accumulator 42. The vacuum should be sufficient to eliminate all thermally conductive heat transfer. Otherwise, the low (e.g., about 16 W) of cooling provided by the cooler 340 can mostly go to cooling the outside of the insulating vessel 440. This vessel 440 is not typically valved off too close to its body when the ¹²⁹Xe is thawed or during thaw to inhibit burst.

Examples of suitable isolation valves 35, 37 and/or for valves V for the pre-sat chamber 200 (FIGS. 1A, 1B), include Swagelok valves or KIMBLE KONTES valves.

In some embodiments, the isolation valves 35, 37 are in communication with the primary flow channel and the (buffer gas) exit/outlet channel 444, respectively, and each can adjust the amount of flow therethrough as well as close the respective paths to isolate the accumulator from the system 10 and the environment.

As will be appreciated by one of skill in the art, embodiments of the invention may be embodied as a method, system, data processing system, or computer program product. Accordingly, the present invention may take the form of an entirely software embodiment or an embodiment combining software and hardware aspects, all generally referred to herein as a “circuit” or “module.” Furthermore, the present invention may take the form of a computer program product on a non-transient computer usable storage medium having computer usable program code embodied in the medium. Any suitable computer readable medium may be utilized including hard disks, CD-ROMs, optical storage devices, a transmission media such as those supporting the Internet or an intranet, or magnetic or other electronic storage devices.

Computer program code for carrying out operations of the present invention may be written in an object-oriented programming language such as Java, Smalltalk, PYTHON, C# or C++. However, the computer program code for carrying out operations of the present invention may also be written in conventional procedural programming languages, such as the “C” programming language or in a visually oriented programming environment, such as LabVIEW or Visual Basic.

Certain or all aspects of the program code may execute entirely on one or more of a user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider). Typically, some program code executes on at least one web (hub) server and some may execute on at least one web client and with communication between the server(s) and clients using the Internet. The polarizer control systems can be provided using cloud computing which includes the provision of computational resources on demand via a computer network. The resources can be embodied as various infrastructure services (e.g., compute, storage, etc.) as well as applications, databases, file services, email, etc. In the traditional model of computing, both data and software are typically fully contained on the user's computer; in cloud computing, the user's computer may contain little software or data (perhaps an operating system and/or web browser) and may serve as little more than a display terminal for processes occurring on a network of external computers. A cloud computing service (or an aggregation of multiple cloud resources) may be generally referred to as the “Cloud.” Cloud storage may include a model of networked computer data storage where data is stored on multiple virtual servers, rather than being hosted on one or more dedicated servers.

The invention is described in part below with reference to flowchart illustrations and/or block diagrams of methods, systems, computer program products and data and/or system architecture structures according to embodiments of the invention. It will be understood that each block of the illustrations, and/or combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer readable memory or storage that can direct a computer or other programmable data processing apparatus to function in a particular manner, such that the instructions stored in the computer readable memory or storage produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowcharts and block diagrams of certain of the figures herein illustrate exemplary architecture, functionality, and operation of possible implementations of embodiments of the present invention. In this regard, each block in the flow charts or block diagrams represents a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order or two or more blocks may be combined, depending upon the functionality involved.

FIG. 13 is a schematic illustration of a circuit or data processing system 400. The circuits and/or data processing systems 400 may be incorporated in a digital signal processor in any suitable device or devices. As shown in FIG. 13, the processor 410 communicates with and/or is integral with the polarizer 10 and with memory 414 via an address/data bus 448. The processor 410 can be any commercially available or custom microprocessor. The memory 414 is representative of the overall hierarchy of memory devices containing the software and data used to implement the functionality of the data processing system. The memory 414 can include, but is not limited to, the following types of devices: cache, ROM, PROM, EPROM, EEPROM, flash memory, SRAM, and DRAM.

FIG. 13 illustrates that the memory 414 may include several categories of software and data used in the data processing system: the operating system 452; the application programs 454; the input/output (I/O) device drivers 458; and data 455. The data 455 can include a heater and cooler timing diagram/control chart for synchronizing timing of manifold valves for ON/OFF position, gas mixture flow rate, time for heater ON for thaw, time for cooler ON for accumulation and the like.

As will be appreciated by those of skill in the art, the operating systems 452 may be any operating system suitable for use with a data processing system, such as OS/2, AIX, or zOS from International Business Machines Corporation, Armonk, NY, Windows CE, Windows NT, Windows95, Windows98, Windows2000, WindowsXP, Windows Visa, Windows7, Windows 8, Windows 8.1, Windows CE or other Windows versions from Microsoft Corporation, Redmond, WA, Palm OS, Symbian OS, Cisco IOS, VxWorks, Unix or Linux, Mac OS from Apple Computer, LabView, or proprietary operating systems.

The I/O device drivers 458 typically include software routines accessed through the operating system 449 by the application programs 454 to communicate with devices such as I/O data port(s), data storage 455 and certain memory 414 components. The application programs 454 are illustrative of the programs that implement the various features of the data processing system and can include at least one application, which supports operations according to embodiments of the present invention. Finally, the data 455 represents the static and dynamic data used by the application programs 454, the operating system 452, the I/O device drivers 458, and other software programs that may reside in the memory 414.

While the present invention is illustrated, for example, with reference to the Cryo-collection Control Circuit and/or Module (“Module”) 450 being an application program in FIG. 13, as will be appreciated by those of skill in the art, other configurations may also be utilized while still benefiting from the teachings of the present invention. For example, the Module may also be incorporated into the operating system 452, the I/O device drivers 458 or other such logical division of the data processing system. Thus, the present invention should not be construed as limited to the configuration of FIG. 13 which is intended to encompass any configuration capable of carrying out the operations described herein. Further, Module 450 can communicate with or be incorporated totally or partially in other components, such as a separate controller for the cryo-collection system 30 (heater 240 and cooler 340) or be incorporated into a single controller and/or processor for the hyperpolarizer 10.

The I/O data port can be used to transfer information between the data processing system and another computer system or a network (e.g., the Internet) or to other devices controlled by the processor. These components may be conventional components such as those used in many conventional data processing systems, which may be configured in accordance with the present invention to operate as described herein.

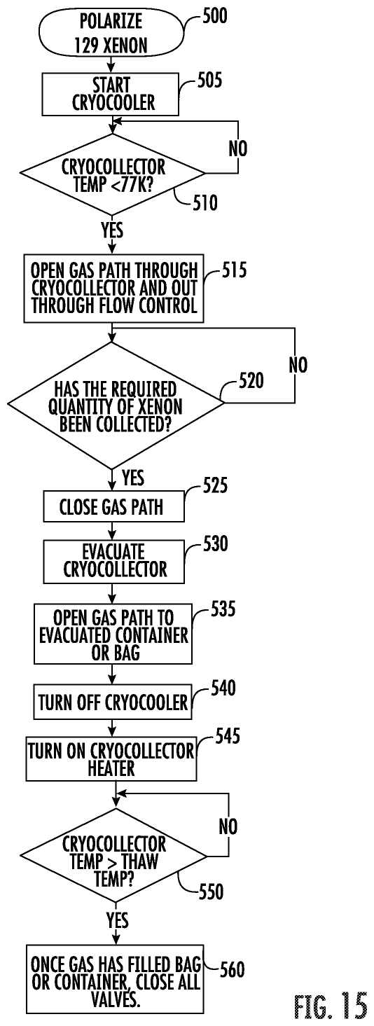

FIG. 15 is a flow chart of example actions that can be used to collect/dispense hyperpolarized ¹²⁹Xe. As shown, ¹²⁹Xe is hyperpolarized (block 500). The cryocooler is electronically started (block 505) to thereby cool a cold finger of the cryocooler. Temperature of the accumulator in the cryo-collector is monitored. When the temperature is at 77K or less, the gas path through the cryo-collector is opened thereby allowing gases to flow out through flow control (block 515). When a desired amount of frozen ¹²⁹Xe has been collected, the gas path out of the cryo-collector is closed (block 525). The cryo-collector 30 can be evacuated (block 530). The exit gas path to the (evacuated) collection container is opened (block 535). The cryocooler is turned off (block 540). The cryo-collector heater is turned on (block 545) before, after or concurrently with turning the cryo-cooler off. Monitor temperature to confirm the accumulator of the cryo-collector is at a temperature above thaw temperature of ¹²⁹Xe (block 550) to thereby dispense thawed ¹²⁹Xe to the collection vessel in the exit flow path. Once a bolus or multiple bolus amount of ¹²⁹Xe gas has been dispensed into the collection vessel, the exit flow path valves can be closed (block 560).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clause are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A cryo-collection system comprising:
an accumulator having an entry conduit, an exit conduit and a gas flow path configured for receiving a gas mixture, wherein the gas flow path is in fluid communication with the entry conduit and the exit conduit;
a heater in thermal communication with the accumulator;
a cooler in thermal communication with the accumulator; and
a controller in communication with the heater and the cooler to direct the cooler to apply a temperature to the accumulator sufficient to freeze a target gas from the gas mixture and collect the target gas in the accumulator, then direct the heater to apply a temperature to the accumulator sufficient to thaw the collected target gas.

2. The cryo-collection system of claim 1, wherein the heater and cooler are both concurrently attached to the accumulator.

3. The cryo-collection system of claim 1, wherein the cooler is configured to cool a surface of the accumulator to a temperature in a range of 77K to 165K, and wherein the heater is configured to heat a surface of the accumulator to thereby initiate thaw.

4. The cryo-collection system of claim 1, wherein the heater is a ceramic heater with an accumulator contact surface having a thickness that is greater than a thickness of a bottom of the accumulator.

5. The cryo-collection system of claim 1, wherein the heater abuts a surface of the accumulator.

6. The cryo-collection system of claim 1, wherein the heater abuts a bottom surface of the accumulator.

7. The cryo-collection system of claim 1, wherein the cooler comprises a Stirling-cycle based cooler with a cold finger that abuts a surface of the accumulator to thermally couple the cooler to the accumulator.

8. The cryo-collection system of claim 1, wherein the accumulator comprises a coupling channel that receives a fixation member to attach the cooler to the accumulator.

9. The cryo-collection system of claim 8, wherein the coupling channel resides in a center location of a bottom of the accumulator.

10. The cryo-collection system of claim 1, wherein the heater has a disk shape with an open center and abuts a portion of a bottom of the accumulator, and wherein the cooler has a cold finger with an end portion that resides in a center space of the heater and abuts a portion of the bottom of the accumulator inside the open center of the disk shape.

11. The cryo-collection system of claim 1, wherein the accumulator comprises a bottom surface, wherein the heater is configured to abut a first portion of the bottom surface and the cooler is configured to abut a second portion of the bottom surface.

12. The cryo-collection system of claim 11, wherein the first portion is annular and the second portion is circular and inside the first portion.

13. The cryo-collection system of claim 1, wherein the accumulator comprises a disk-shaped body with an interior comprising a plurality of baffles that cooperate to define at least a portion of the gas flow path.

14. The cryo-collection system of claim 1, further comprising a vacuum insulated vessel that encloses at least part of the accumulator, at least part of the heater and at least an end portion of a cold finger of the cooler.

15. The cryo-collection system of claim 1, wherein the accumulator comprises a first tube that couples to the entry conduit and a second tube that couples to the exit conduit, wherein the first and second tubes are non-ferromagnetic metal and the entry and exit conduits comprise glass and/or a polymer and are less thermally conductive than the first and second tubes.

16. The cryo-collection system of claim 1, wherein the accumulator has a low mass body in a range of 40 grams to 200 grams.

17. The cryo-collection system of claim 1, wherein the target gas is ¹²⁹Xe, and wherein the gas mixture is a hyperpolarized gas mixture comprising ¹²⁹Xe.

18. An accumulator for a cryo-collection system, comprising:
a disk-shaped body enclosing at least a portion of a serpentine gas mixture flow path; and
first and second spaced apart tubes attached to or formed by the disk-shaped body and in fluid communication with the gas mixture flow path.

19-20. (canceled)

21. A flow-through spin exchange optical pumping (SEOP) hyperpolarized gas production system for producing hyperpolarized gas comprising:
a pressurized gas mixture;
a flow-through optical pumping cell in fluid communication with the pressurized gas mixture; and
the cryo-collection system of claim 1 downstream of and in fluid communication with the flow-through optical pumping cell.

22. The flow-through SEOP gas production system of claim 21, further comprising a flexible patient dose delivery bag downstream of the cryo-collection system and comprising an inhalable bolus of hyperpolarized ¹²⁹Xe collected, then thawed by the cryo-collection system.

23. The flow-through SEOP gas production system of claim 21, wherein the accumulator, heater and cooler are provided as a first cryo-collection system in a first vacuum insulated vessel, wherein the flow-through OSEP gas production system further comprises a second cryo-collection system downstream of and in fluid communication with the optical pumping cell, wherein the second cryo-collection system is provided in a second vacuum insulated vessel enclosing a second heater and at least a portion of a second cooler, and wherein the first and second cryo-collection systems are serially and alternately operable to collect frozen ¹²⁹Xe from the hyperpolarized gas mixture from the optical pumping cell.

24. A method of collecting hyperpolarized ¹²⁹Xe, comprising:
providing a cryo-collection system comprising an accumulator, an integrated cooler and integrated heater;
electronically directing the cooler to cool the accumulator to a sufficient temperature to freeze and collect hyperpolarized ¹²⁹Xe from a gas mixture;
electronically directing operation of the heater to heat to a sufficient temperature to thaw the collected hyperpolarized ¹²⁹Xe in the accumulator; and
then flowing the hyperpolarized ¹²⁹Xe out of the accumulator into an enclosed flow path.

25-32. (canceled)
